(19) United States
(12) Patent Application Publication
(10) Pub. No.: US 2016/0189874 A1
(43) Pub. Date: Jun. 30, 2016

(54) ELECTRODE STRUCTURE FOR CAPACITOR, ELECTROLYTIC CAPACITOR, AND METHOD OF MANUFACTURING THE SAME

(71) Applicant: SAMSUNG ELECTRO-MECHANICS CO., LTD., Suwon-Si (KR)

(72) Inventor: Kwi Jong LEE, Suwon-Si (KR)

(21) Appl. No.: 14/958,588

(22) Filed: Dec. 3, 2015

(30) Foreign Application Priority Data
Dec. 30, 2014 (KR) 10-2014-0193214

(51) Int. Cl. H01G 9/042; H01G 9/048; H01G 9/00; H01G 9/145

(52) U.S. Cl. CPC H01G 9/0425; H01G 9/145; H01G 9/048; H01G 9/0029; H01G 2009/05

(57) ABSTRACT

An electrode structure for a capacitor, an electrolytic capacitor, and a method of manufacturing the same are provided. An electrode structure for a capacitor includes a polymer film; a thin-film electrode layer disposed on the polymer film; and a metal oxide layer disposed on the thin-film electrode layer.

### CROSS-REFERENCE TO RELATED APPLICATION

This application claims benefit of priority to Korean Patent Application No. 10-2014-0193214 filed on Dec. 30, 2014, with the Korean Intellectual Property Office, the disclosure of which is incorporated herein by reference.

### TECHNICAL FIELD

The present disclosure relates to an electrode structure for a capacitor, an electrolytic capacitor, and a method of manufacturing the same. More particularly, the present disclosure relates to an electrode structure for a capacitor in which a thin-film electrode layer and a metal oxide layer are formed on a polymer film, an electrolytic capacitor, and a method of manufacturing the same.

### BACKGROUND

An electrolytic capacitor has higher capacitance than that of a general capacitor. There are various electrolytic capacitors. For example, an aluminum electrolytic capacitor has significantly high capacitance by anodizing a surface of aluminum to finely form an oxide (Al₂O₃) layer and have a wide surface area with a thin dielectric layer.

A structure of the aluminum electrolytic capacitor will be schematically described. An aluminum oxide (Al₂O₃) layer may be formed on the surface of aluminum foil by anodizing the aluminum foil in an aqueous solution of phosphoric acid, sulfuric acid, or the like. The aluminum foil acts as an anode, a newly formed aluminum oxide acts as a dielectric material, and a liquid electrolyte layer acts as a cathode. When a film is wound to package the film in a capacitor cylinder, a space is formed in order to maintain a predetermined interval.

In order to increase charge capacity of the aluminum electrolytic capacitor, a dielectric thickness and a surface area should be increased. The dielectric thickness may be adjusted by operation parameters depending on an applied voltage, time, and the like, in the anodizing. In order to increase the surface area, large amounts of foil and spacer should be combined into a capacitor container having the same volume. There is a need to decrease a thickness of the aluminum foil itself and a thickness of the spacer. However, when the thickness of the aluminum foil is decreased, there is a difficulty in the anodizing and handling at the time of assembly. Thus, there is a limitation in implementing thinness.

Although the aluminum electrolytic capacitor is described above by way of example, it is also difficult to implement thinness in other electrolytic capacitors.

### SUMMARY

An aspect of the present disclosure may provide an electrode structure for a capacitor in which a thin-film electrode layer and a metal oxide layer are formed on a polymer film to implement an electrolytic capacitor having reduced thickness and flexibility, an electrolytic capacitor, and a method of manufacturing the same.

According to an aspect of the present disclosure, an electrode structure for a capacitor may include a polymer film, a thin-film electrode layer disposed on the polymer film, and a metal oxide layer disposed on the thin-film electrode layer.

For example, the thin-film electrode layer may contain a first metal ingredient, and the metal oxide layer may be an oxide layer of the first metal ingredient. Alternatively, the thin-film electrode layer may contain a second metal ingredient, and the metal oxide layer may contain an oxide of a first metal different from a second metal. The polymer film may contain any one of polyester based polymer ingredients, polyimide based polymer ingredients, and polypropylene based polymer ingredients.

According to another aspect of the present disclosure, an electrolytic capacitor may include the electrode structure for a capacitor as described above, and a cathode structure disposed on the electrode structure. In this case, the electrolytic capacitor may be provided as a film type electrolytic capacitor.

The cathode structure may include an electrolyte layer disposed on the electrode structure and a first metal electrode layer disposed on the electrolyte layer. Alternatively, the cathode structure may further include a non-metal conductive layer between the electrolyte layer and the first metal electrode layer.

According to another aspect of the present disclosure, a method of manufacturing an electrolytic capacitor may include forming an electrode structure including a thin-film electrode layer formed on a polymer film and a metal oxide layer formed on the thin-film electrode layer, and forming a cathode structure on the metal oxide layer.

For example, a first metal may be deposited on the polymer film, and the metal oxide layer may be formed by anodizing a surface of the first metal. Alternatively, after a second metal is deposited on the polymer film, a first metal layer different from the second metal may be formed on a second metal layer, and anodization may be performed to a surface of the first metal layer.

In addition, as an example, a conductive electrolyte layer may be formed on the metal oxide layer, and a first metal electrode layer may be formed on the conductive electrolyte layer, thereby forming the cathode structure. Alternatively, after a non-metal conductive layer is formed on the conductive electrolyte layer, the first metal electrode layer may be formed on the non-metal conductive layer.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a cross-sectional view schematically illustrating an electrode structure for a capacitor according to an exemplary embodiment in the present disclosure;

FIG. 2 is a cross-sectional view schematically illustrating an electrode structure for a capacitor according to another exemplary embodiment in the present disclosure;

FIG. 3A is a view schematically illustrating a cross section of an electrolytic capacitor according to another exemplary embodiment in the present disclosure;

FIG. 3B is a view schematically illustrating a cross section of an electrolytic capacitor according to another exemplary embodiment in the present disclosure;

FIG. 4 is a cross-sectional view schematically illustrating a surface boundary of a metal oxide layer of the electrolytic capacitor according to an exemplary embodiment in the present disclosure;

FIGS. 5A through 5D are views schematically illustrating each operation of a manufacturing method of an electrolytic capacitor according to another exemplary embodiment in the present disclosure, respectively; and

FIGS. 6A through 6E are views schematically illustrating each operation of a manufacturing method of an electrolytic capacitor according to another exemplary embodiment in the present disclosure, respectively.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

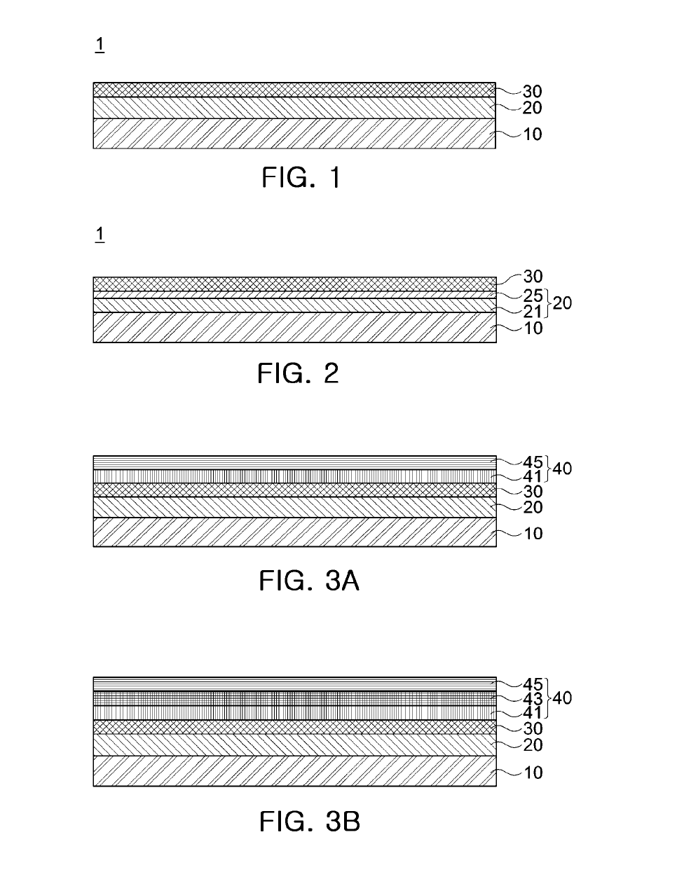

FIG. 1 is a cross-sectional view schematically illustrating an electrode structure for a capacitor according to an exemplary embodiment, and FIG. 2 is a cross-sectional view schematically illustrating an electrode structure for a capacitor according to another exemplary embodiment.

An electrode structure for a capacitor according to the exemplary embodiment will be described with reference to FIG. 1 and/or FIG. 2. The electrode structure 1 for a capacitor may include a polymer film 10, a thin-film electrode layer 20, and a metal oxide layer 30. In this case, the electrode structure 1 for a capacitor may be a structure using the thin-film electrode layer 20 as an anode. Each configuration will be described in more detail.

The thin-film electrode layer 20 may be formed on the polymer film 10. The electrode structure 1 for a capacitor having reduced thickness and flexibility may be implemented by forming the thin-film electrode layer 20 on the polymer film 10.

Here, according to an exemplary embodiment, the polymer film 10 may contain any one of polyester based polymer ingredients, polyimide based polymer ingredients, and polypropylene based polymer ingredients, but the ingredient of the polymer film is not limited thereto.

For example, a film type electrode structure 1 for a capacitor may be manufactured by forming the thin-film electrode layer 20 and the metal oxide layer 30 on the polymer film 10. The electrode structure 1 for a capacitor according to the exemplary embodiment may be applied to other electrolytic capacitors as well as the film type electrolytic capacitor.

Next, the thin-film electrode layer 20 and the metal oxide layer 30 will be described. The thin-film electrode layer 20 may be formed on the polymer film 10, and the metal oxide layer 30 may be formed on the thin-film electrode layer 20. Here, the thin-film electrode layer 20 may act as the anode of the capacitor.

According to an exemplary embodiment, the metal oxide layer 30 may be an oxide layer of a metal ingredient of the thin-film electrode layer 20. For example, the thin-film electrode layer 20 may contain a first metal ingredient, and the metal oxide layer 30 may be formed by anodizing the same first metal ingredient. For example, a surface of a first metal layer deposited on the polymer film 10 is oxidized, and thus the metal oxide layer 30 may be formed. For example, in a case in which the thin-film electrode layer indicated by reference numeral 20 of FIG. 1 is the first metal layer, a part indicated by reference numeral 30 may be a surface oxidation layer of the first metal. Further, referring to FIG. 2, in a case in which in the thin-film electrode layer is indicated by reference numeral 20, apart indicated by reference numeral 25 is the first metal layer 25, and a part indicated by reference numeral 30 may be a surface oxidation layer of the first metal layer 25.

In this case, examples of the first metal may include aluminum (Al), tantalum (Ta), niobium (Nb), vanadium (V), titanium (Ti), hafnium (Hf), zirconium (Zr), and the like.

Alternatively, according to an exemplary embodiment, the thin-film electrode layer 20 may contain a second metal ingredient, and the metal oxide layer 30 may contain an oxide of a first metal different from the second metal ingredient. For example, the thin-film electrode layer indicated by reference numeral 20 of FIG. 1 may contain the second metal ingredient, and the part indicated by reference numeral 30 may be an oxide layer formed by oxidation of the first metal different from a second metal. Alternatively, the thin-film electrode layer indicated by reference numeral 20 of FIG. 2 may be composed of a second metal layer 21 containing a second metal ingredient and a first metal layer 25 containing a first metal ingredient different from the second metal, and the metal oxide layer indicated by reference numeral 30 may be an oxide layer formed by oxidation of a surface of the first metal layer 25 formed of the first metal different from the ingredient of the second metal layer 21.

In this case, the second metal ingredient may be one of copper (Cu), titanium (Ti), nickel (Ni), and silver (Ag), but is not limited thereto.

Further, the first metal may be one of aluminum (Al), tantalum (Ta), niobium (Nb), vanadium (V), hafnium (Hf), and zirconium (Zr), but is not limited thereto.

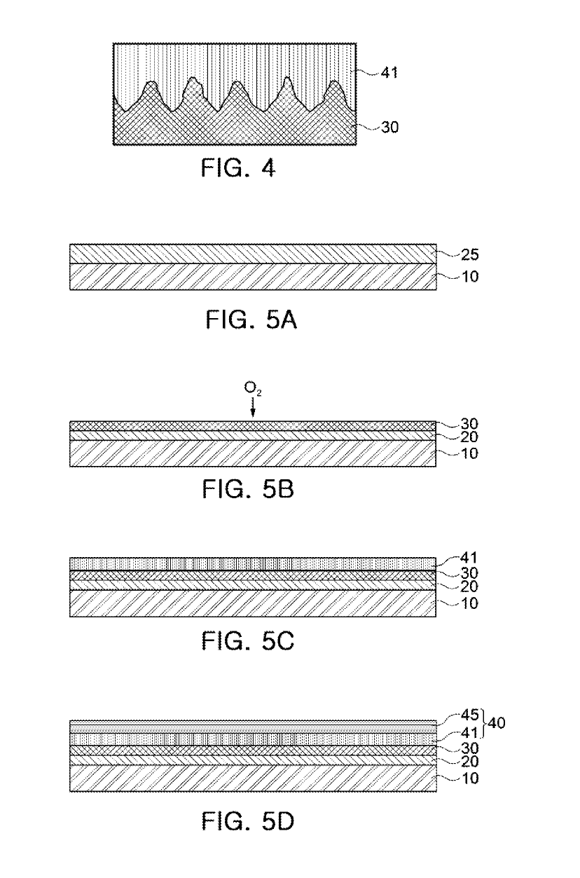

For example, referring to FIG. 4, roughness may be formed on a surface of the metal oxide layer 30. A surface area of the metal oxide layer 30 may be increased by the surface roughness, and thus capacitance may be improved. For example, a metal layer may be formed to have roughness on a surface thereof by depositing a metal thin film, and the metal oxide layer 30 on which surface roughness is formed may be formed by oxidizing a surface of the metal layer. Alternatively, the roughness may be formed by surface-treating the surface of the metal layer using an ion source, or the like.

Next, an electrolytic capacitor according to another exemplary embodiment will be described in detail with reference to the accompanying drawings. Here, the electrode structure for a capacitor according to the exemplary embodiments as described above and FIGS. 1 and 2 will be used for reference, and thus an overlapping description will be omitted.

FIG. 3A is a view schematically illustrating a cross section of an electrolytic capacitor according to another exemplary embodiment, FIG. 3B is a view schematically illustrating a cross section of an electrolytic capacitor according to another exemplary embodiment, and FIG. 4 is a cross-sectional view schematically illustrating a surface boundary of a metal oxide layer 30 of the electrolytic capacitor according to an exemplary embodiment.

Referring to FIG. 3A and/or FIG. 3B, the electrolytic capacitor according to the exemplary embodiment may include an electrode structure for a capacitor (see reference numeral 1 of FIGS. 1 and 2) and a cathode structure 40. Here, in FIG. 3A and/or FIG. 3B, a multilayer structure of parts indicated by reference numerals 10, 20, and 30 may be the electrode structure for a capacitor. The cathode structure 40 may be formed on the electrode structure for a capacitor (see reference numeral 1 of FIGS. 1 and 2), specifically, on a metal oxide layer 30.

In this case, the electrode structure for a capacitor (see reference numeral 1 of FIGS. 1 and 2) may be one of the examples of the electrode structure for a capacitor according to the exemplary embodiment described above. Therefore, a detailed description thereof will be omitted, and the above-mentioned description may be used for reference. In this case, although the multilayer structure of the parts indicated by reference numerals 10, 20, and 30 is illustrated in FIGS. 3A and 3B, the multilayer structure of the parts indicated by reference numerals 10, 20, and 30 may have the same structure as in FIG. 2.

For example, the electrolytic capacitor may be a film type electrolytic capacitor. Therefore, an electrolytic capacitor having reduced thickness and flexibility may be implemented. Several layers of the manufactured film may be stacked and used. Alternatively, the manufactured film may be rolled in a cylindrical shape and used. In addition, a lead wire (not illustrated) for connection with an external power supply may be included.

According to an exemplary embodiment, referring to FIG. 3A, the cathode structure 40 may include an electrolyte layer 41 and a first metal electrode layer 45. The electrolyte layer 41 may be formed on the electrode structure for a capacitor (see reference numeral 1 of FIGS. 1 and 2). For example, the electrolyte layer 41 may be formed of a conductive electrolyte. Equivalent series resistance (ESR) may be improved by forming the conductive electrolyte layer 41. The conductive electrolyte may be formed of, for example, a conductive polymer material.

In this case, the first metal electrode layer 45 may be formed on the electrolyte layer 41. For example, a first metal forming the first metal electrode layer 45 may be copper (Cu), nickel (Ni), silver (Ag), or the like.

Further, referring to FIG. 3B, according to an exemplary embodiment, the cathode structure 40 may include a non-metal conductive layer 43 between the electrolyte layer 41 and the first metal electrode layer 45. The non-metal conductive layer 43 may be, for example, a carbon layer.

For example, referring to FIG. 4, roughness may be formed on a surface of the metal oxide layer 30 contacting the cathode structure 40.

Next, a method of manufacturing an electrolyte capacitor according to another exemplary embodiment will be described in detail with reference to the accompanying drawings. Here, the electrode structure for a capacitor according to the exemplary embodiments described above, the electrolytic capacitors according to other exemplary embodiments described above, and FIGS. 1 through 4 will be used for reference, and thus, an overlapping description thereof will be omitted.

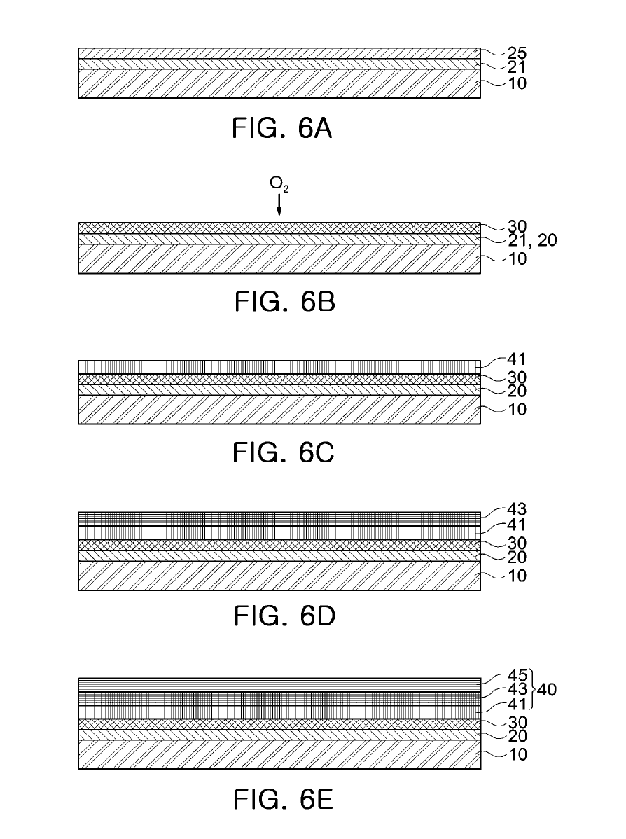

FIGS. 5A through 5D are views schematically illustrating each operation of a method of manufacturing an electrolytic capacitor according to another exemplary embodiment, respectively, and FIGS. 6A through 6E are views schematically illustrating each operation of a method of manufacturing an electrolytic capacitor according to another exemplary embodiment, respectively.

Referring to FIGS. 5A through 5D and/or FIGS. 6A through 6E, the method of manufacturing an electrolytic capacitor according to an exemplary embodiment may include forming an electrode structure (see FIGS. 5A and 5B and/or FIGS. 6A and 6B) and forming a cathode structure (see FIGS. 5C and 5D and/or FIGS. 6C through 6E). Each operation will be described in detail with reference to the accompanying drawings.

First, the forming of the electrode structure will be described with reference to FIGS. 5A and 5B and/or FIGS. 6A and 6B. In the forming of the electrode structure, an electrode structure 1 including a polymer film 10, a thin-film electrode layer 20 formed on the polymer film 10, and a metal oxide layer 30 formed on the thin-film electrode layer 20 (see reference numerals 1, 10, 20, and 30 of FIGS. 1 and 2) may be formed. Here, a detailed description of the electrode structure refers to the above-mentioned description of the electrode structures for a capacitor according to exemplary embodiments.

Referring to FIGS. 5A and 5B and/or FIGS. 6A and 6B, according to an exemplary embodiment, the forming of the electrode structure may include depositing a metal thin film (see FIG. 5A and/or FIG. 6A) and forming a metal oxide layer (see FIG. 5B and/or FIG. 6B). Here, in the forming of the metal oxide layer (see FIG. 5B and/or FIG. 6B), an unoxidized metal layer may become the thin-film electrode layer 20.

For example, referring to FIG. 5A, according to an exemplary embodiment, in the depositing of the metal thin film, a first metal, for example, a first metal layer 25 may be deposited as a thin film on a prepared polymer film 10. In this case, examples of the first metal deposited as the thin film may include aluminum (Al), tantalum (Ta), niobium (Nb), vanadium (V), titanium (Ti), hafnium (Hf), zirconium (Zr), and the like. Further, the polymer film 10 may contain any one of polyester based polymer ingredients, polyimide based polymer ingredients, and polypropylene based polymer ingredients, but the ingredient of the polymer film is not limited thereto. For example, referring to FIG. 4, roughness may be formed on a surface of the deposited first metal.

Then, referring to FIG. 5B, in the forming of the metal oxide layer, the metal oxide layer 30 may be formed by anodizing the surface of the first metal layer 25 deposited as the thin film. In this case, since anodization is performed on a surface region of the first metal layer, an unoxidized first metal layer 25 below the metal oxide layer 30 may become the thin-film electrode layer 20.

Next, FIGS. 6A and 6B will be described. Referring to FIG. 6A, according to an exemplary embodiment, the depositing of the metal thin film may include depositing a second metal thin film and forming a first metal thin film. First, in the depositing of the second metal thin film, a second metal may be deposited as a thin film on a prepared polymer film 10, thereby forming a second metal layer 21. The second metal ingredient may be, for example, one of copper (Cu), titanium (Ti), nickel (Ni), and silver (Ag), but is not limited thereto. Further, the polymer film 10 may contain any one of polyester based polymer ingredients, polyimide based polymer ingredients, and polypropylene based polymer ingredients, but the ingredient of the polymer film is not limited thereto.

Thereafter, in the forming of the first metal thin film, a first metal layer 25 may be formed of a first metal different from the second metal on the second metal layer 21 deposited as the thin film. The first metal layer 25 may be formed on the second metal layer 21 by a deposition method, a plating method, or the like. A thickness of the first metal layer 25 may be in a range of several tens of nm to several um, but is not limited thereto. Here, the first metal may be one of aluminum (Al), tantalum (Ta), niobium (Nb), vanadium (V), hafnium (Hf), and zirconium (Zr), but is not limited thereto. For example, referring to FIG. 4, roughness may be formed on a surface of the first metal.

Then, referring to FIG. 6B, in the forming of the metal oxide layer, the metal oxide layer 30 may be formed by anodizing at least a surface of the first metal layer 25. A case in which the first metal layer 25 is entirely anodized is illustrated in FIG. 6B, but in FIG. 2, a case in which only a surface region of the first metal layer 25 is anodized to form the metal oxide layer 30 is illustrated. In this case, the metal layer that is not anodized, that is, the unoxidized metal layer below the metal oxide layer 30 may become a thin-film electrode layer 20. Here, referring to FIG. 6B, the unoxidized metal layer may be the second metal layer 21. Alternatively, referring to FIG. 2, the unoxidized metal layer may include the second metal layer 21 and the unoxidized first metal layer 25.

Next, the forming of the cathode structure will be described with reference to FIGS. 5C and 5D and/or FIGS. 6C through 6E. In the forming of the cathode structure, the cathode structure 40 may be formed on the metal oxide layer 30 of the electrode structure 1 (see reference numerals 1, 10, 20, and 30 of FIGS. 1 and 2). In this case, although a case in which at the time of performing the operations illustrated in FIGS. 5C and 5D and FIGS. 6C through 6E, operations of FIGS. 5C and 5D are performed after an operation of FIG. 5B, and operations of FIGS. 6C through 6E are performed after an operation of FIG. 6B is illustrated, the operations may be alternately performed with each other. That is, the operations of FIGS. 6C through 6E may be performed after the operation of FIG. 5B, and the operations of FIGS. 5C and 5D may be performed after the operation of FIG. 6B. In addition, although the forming of the cathode structure 40 on the electrode structure 1 as illustrated in FIG. 1 is illustrated in FIGS. 5C and 5D and FIGS. 6C through 6E, the forming of the cathode structure 40 of FIGS. 5C and 5D or FIGS. 6C through 6E may also be performed on the electrode structure 1 as illustrated in FIG. 2.

Further, although not illustrated, in the forming of the cathode structure, the cathode structure 40 may also be formed by dipping the electrode structure formed in the forming of the electrode structure and the first metal electrode layer 45 in an electrolyte solution in a state in which a spacer, for example, papers, or the like, is inserted therebetween and wound together with the electrode structure and the first metal electrode layer 45 in a cylindrical shape to allow an electrolyte solution to permeate into a space between the metal oxide layer 30 and the first metal electrode layer 45.

The forming of the cathode structure according to an exemplary embodiment will be described with reference to FIGS. 5C and 5D. The forming of the cathode structure may include forming a conductive electrolyte layer and forming a first metal electrode layer. Referring to FIG. 5C, in the forming of the conductive electrolyte layer, a conductive electrolyte layer 41 may be formed on the metal oxide layer 30 of the electrode structure. The conductive electrolyte layer 41 may be formed of, for example, a conductive polymer material. For example, a conductive polymer layer may be formed on the metal oxide layer 30 by impregnating the multilayer structure in a conductive polymer aqueous solution, picking out the multilayer structure, and then performing heat-treatment.

Next, referring to FIG. 5D, in the forming of the first metal electrode layer, the first metal electrode layer 45 may be formed on the conductive electrolyte layer 41. The first metal electrode layer 45 may be formed by a deposition method, a plating method, or the like. Since the first metal electrode layer 45 is formed on the conductive electrolyte layer 41, the first metal electrode layer 45 may be formed on the conductive electrolyte layer 41 by a deposition method, a plating method, or the like, as illustrated in FIG. 5D. Alternatively, although not directly illustrated, referring to FIG. 6E, a conductor layer formed of a different material is formed on the conductive electrolyte layer 41, and the first metal electrode layer 45 may be formed on the conductor layer formed of the different material. For example, a first metal forming the first metal electrode layer 45 may be copper (Cu), nickel (Ni), silver (Ag), or the like.

Next, referring to FIGS. 6C through 6E, the forming of the cathode structure according to an exemplary embodiment may further include forming a non-metal conductive layer (see FIG. 6D) between the forming of the conductive electrolyte layer (see FIG. 6C) and the forming of the first metal electrode layer (see FIG. 6E). That is, referring to FIG. 6C, in the forming of the conductive electrolyte layer, the conductive electrolyte layer 41 may be formed on the metal oxide layer 30 of the electrode structure, and referring to FIG. 6D, in the forming of the non-metal conductive layer, a non-metal conductive layer 43 may be formed on the conductive electrolyte layer 41. In this case, the non-metal conductive layer 43 may be formed of a carbon material. For example, the non-metal conductive layer 43 may be formed on the conductive electrolyte layer 41 by a carbon deposition method. In addition, referring to FIG. 6E, the first metal electrode layer 45 may be formed on the non-metal conductive layer 43. In this case, the first metal electrode layer 45 may be formed by a deposition method, a plating method, or the like. For example, a first metal forming the first metal electrode layer 45 may be copper (Cu), nickel (Ni), silver (Ag), or the like.

As set forth above, according to exemplary embodiments, the capacitor having reduced thickness and flexibility may be implemented by implementing the electrode structure for a capacitor in which the thin-film electrode layer and the metal oxide layer are formed on the polymer film.

Therefore, the electrolytic capacitor having reduced thickness and flexibility may be implemented.

While exemplary embodiments have been shown and described above, it will be apparent to those skilled in the art that modifications and variations could be made without departing from the scope of the present invention as defined by the appended claims.

What is claimed is:

1. An electrode structure for a capacitor comprising:
a polymer film;
a thin-film electrode layer disposed on the polymer film; and
a metal oxide layer disposed on the thin-film electrode layer.

2. The electrode structure for a capacitor of claim 1, wherein the thin-film electrode layer comprises a first metal ingredient, and
the metal oxide layer is an oxide layer of the first metal ingredient.

3. The electrode structure for a capacitor of claim 1, wherein the thin-film electrode layer contains a second metal ingredient, and
the metal oxide layer contains an oxide of a first metal ingredient different from the second metal ingredient.

4. The electrode structure for a capacitor of claim 3, wherein the second metal ingredient is one of copper (Cu), titanium (Ti), nickel (Ni), and silver (Ag), and
the first metal ingredient is one of aluminum (Al), tantalum (Ta), niobium (Nb), vanadium (V), hafnium (Hf), and zirconium (Zr).

5. The electrode structure for a capacitor of claim 3, wherein the thin-film electrode layer further contains an unoxidized first metal ingredient interposed between the second metal ingredient and the metal oxide layer.

6. The electrode structure for a capacitor of claim 3, wherein the second metal ingredient and the metal oxide layer directly contact each other.

7. The electrode structure for a capacitor of claim 1, wherein the polymer film contains one of polyester based polymer ingredients, polyimide based polymer ingredients, and polypropylene based polymer ingredients.

8. The electrode structure for a capacitor of claim 1, wherein the thin-film electrode layer acts as an anode.

9. A method of manufacturing an electrolytic capacitor, comprising:
forming a polymer film;
forming a thin-film electrode layer on the polymer film;
forming a metal oxide layer on the thin-film electrode layer so as to form an electrode structure including the polymer film, the thin-film electrode layer, and the metal oxide layer; and
forming a cathode structure on the metal oxide layer.

10. The method of claim 9, wherein the forming of the electrode structure comprises:
depositing a first metal as a thin film on the polymer film; and
anodizing a surface of the first metal deposited as the thin film to form the metal oxide layer, and
an unoxidized metal layer below the metal oxide layer is provided as the thin-film electrode layer.

11. The method of claim 9, wherein the forming of the electrode structure includes:
depositing a second metal using a second metal on the polymer film;
forming a first metal layer using a first metal different from the second metal on the second metal layer; and
anodizing at least a surface of the first metal layer to form the metal oxide layer and converting an unoxidized metal layer between the metal oxide layer and the polymer film to the thin-film electrode layer.

12. The method of claim 11, wherein the second metal is one of copper (Cu), titanium (Ti), nickel (Ni), and silver (Ag), and
the first metal is one of aluminum (Al), tantalum (Ta), niobium (Nb), vanadium (V), hafnium (Hf), and zirconium (Zr).

13. The method of claim 11, wherein the entire first metal layer is converted to the metal oxide layer by anodizing.

14. The method of claim 9, wherein the polymer film contains any one of polyester based polymer ingredients, polyimide based polymer ingredients, and polypropylene based polymer ingredients.

15. The method of claim 9, wherein the forming of the cathode structure comprises: forming a conductive electrolyte layer on the metal oxide layer; and forming a first metal electrode layer on the conductive electrolyte layer.

16. The method of claim 15, wherein the forming of the cathode structure further comprises forming a non-metal conductive layer on the conductive electrolyte layer, and
the first metal electrode layer is formed on the non-metal conductive layer.

17. An electrolyte capacitor comprising:
an electrode structure including a polymer film, a metal oxide layer, and a thin-film electrode layer interposed between the polymer film and the metal oxide layer;
a first metal electrode layer; and
a conductive electrolyte layer interposed between the metal oxide layer of the electrode structure and the first metal electrode layer.

18. The electrolyte capacitor of claim 17, wherein the thin-film electrode layer comprises a first metal ingredient, and the metal oxide layer is an oxide layer of the first metal ingredient.

19. The electrolyte capacitor of claim 18, wherein the thin-film electrode layer further comprises a second metal ingredient interposed between the first metal ingredient and the polymer film.

20. The electrolyte capacitor of claim 17, wherein the metal oxide layer is an oxide layer of a first metal ingredient, and the thin-film electrode layer comprises a second metal ingredient in direct contact with the first metal oxide layer.
